(19) United States
(12) Patent Application Publication
(10) Pub. No.: US 2008/0198127 A1
(43) Pub. Date: Aug. 21, 2008

(54) Display Apparatus

(75) Inventor: Alain Decraemer, Brugge (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,916

(22) PCT Filed: Oct. 13, 2005
(86) PCT No.: PCT/IB05/53368

§ 371 Date: Apr. 9, 2007

(30) Foreign Application Priority Data
Oct. 14, 2004 (EP) 04105053.5

(51) Int. Cl. G09G 3/36

(52) U.S. Cl. 345/102

(57) ABSTRACT

The display apparatus (10) includes a signal processor (20), an illumination source (40) and a pixel array (50) for optically modulating the light generated by the illumination source (40) to generate a series of images for user-viewing. The illumination source (40) comprises a plurality of individually addressable segments (s₁ to sₙ; s_{1,1} to s_{p,q}) for generating light and having mutually independently controllable light emissions. The signal processor (20) processes and input signal (vᵢ) to drive the illumination source (40) and the pixel array (50) so as to display the series of images corresponding to the input signal (vᵢ). The segments (s₁ to sₙ; s_{1,1} to s_{p,q}) of the illumination source (40) are excited in operation by the signal processor (20) in response to a degree of motion occurring in corresponding parts of the input signal (vᵢ).

### FIELD OF THE INVENTION

The present invention relates to a display apparatus including an illumination source and a pixel array. The invention also relates to a method of operating such a display apparatus.

### BACKGROUND TO THE INVENTION

Image displays apparatus are known, wherein the apparatus are operable to receive image signals and generating corresponding images for user viewing. There are now several display technologies commercially available for implementing such display apparatus, for example cathode ray tubes (CRT), plasma panels display (PDP), organic light emitting diode displays (O-LED), polymer light emitting diode displays (Poly-LED) and liquid crystal displays (LCD). Whereas pixels of O-LED and poly-LED displays respond substantially instantaneously when energized by electrical signals applied thereto, similar to CRT when implemented using rapid response phosphors, LCD pixels exhibit a relatively long response time constant to such electrical excitation, for example several milliseconds are required for LCD optically-active molecules to twist and untwist in response to an applied electric field. This relatively long response time constant for LCD's is a known problem that can render animated temporal sequences of images presented on such LCD's in a blurred way to users.

The problem of relatively slow LCD response is known in the prior art and various solutions have been proposed. Many LCD's, for example as utilized in many contemporary products such as lap-top personal computers, mobile telephones, LCD televisions, employ back-lighting for providing a source of illumination which is subsequently spatially selectively filtered by a matrix of active LCD pixel elements. It is known to employ various types of modulation of the back-lighting so as to illuminate the LCD pixels only when their optical transmission state has stabilized, thereby reducing subjective appearance of blurring to users viewing the pixels.

For example, WO 2004/044878 describes the use of swept LCD back-lighting to reduce subjective motion blurring due to LCD pixel response lag in LCD pixel array projection displays. As a further example, a published WO 03/101086 describes employing a varying duty cycle of excitation to LCD back-lighting to reduce motion blurring due to LCD pixel response lag in LCD's.

Whereas the spatial swept modulation of LCD back-lighting is complex to implement on account of utilizing mechanical optical beam scanning arrangements or fast-responding multiple inverters for energizing corresponding associated segments of LCD back-lighting units, varying duty cycle back-light modulation can result in loss of LCD brightness due to reduced pulse width modulated (PWM) excitation during periods of motion and can give rise to overall display flicker which can be fatiguing to users or viewers.

These contemporary known solutions to LCD blurring phenomena are therefore non-optimal and can result in increased cost and/or complexity of LCD displays. The inventors have therefore devised the present invention to address these contemporary problems with back-lit LCD's and similar types of display technologies exciting relatively long pixel response times.

### SUMMARY OF THE INVENTION

An object of the present invention is to provide a display apparatus, which is susceptible to exhibiting less noticeable blurring in use when moving images are presented thereon.

According to an aspect of the present invention, there is provided a display apparatus including:
(a) an illumination source comprising a plurality of individually addressable segments for generating light and having mutually independently controllable light emissions;
(b) a pixel array for optically modulating the light generated by the illumination source to generate a series of images for user-viewing; and
(c) a signal processor for processing an input signal to drive the illumination source and the pixel array so as to display the series of images corresponding to the input signal, wherein the segments of the illumination source are excited in operation by the signal processor in response to a degree of motion occurring in corresponding parts of the input signal.

With corresponding parts of the input signal is meant those parts of the input signal that correspond to regions of images being displayed on regions of the pixel array, which receive light from the corresponding segments of the illumination source. By exciting the segments in dependence on the degree of motion in the corresponding parts of the input signal, the display apparatus is capable to reduce blurring by, for example, exciting segments corresponding to parts where motion is detected in a blinking manner, while in stationary parts of the input signal, the segment may be continuously excited. So, the invention is of advantage in that the display apparatus is capable of exhibiting less noticeable image blurring thereon when in operation.

The invention is defined by the independent claims. The dependent claims define advantageous embodiments.

Optionally, in the display apparatus, the signal processor is operable to excite one or more of the segments of the illumination source in a blinking manner when images presented in corresponding regions of the pixel array include considerable motion susceptible to being perceived as image blurring. The excitation in a blinking manner reduces this motion blur, however the blinking may introduce some noticeable flicker of the displayed images. Use of the blinking illumination for selected regions of the pixel array is susceptible of combining benefits of reducing motion blurring visible on the pixel array whilst minimizing the flicker by allowing other regions of the pixel array to be illuminated continuously and thereby appearing flicker free.

Optionally, in the display apparatus, the signal processor is operable to excite one or more of the segments of the illumination source in a continuous non-blinking manner and/or in a high-frequency strobed manner whereat flicker is substantially indiscernible when images presented in corresponding regions of the pixel array include motion of substantially insufficient rapidity to cause user-perceivable blurring.

The signal processor may be operable to excite one or more of the segments in a blinking manner when corresponding parts of the input signal include a degree of motion, which exceeds a predetermined value.

More optionally, in the display apparatus, illumination generated by the one or more segments excited in the blinking manner is subject to elevated peak illumination so that the generated illumination therefrom is on average at a comparable level to segments of the illumination source excited in a non-blinking continuous and/or high-frequency strobed manner. By employing blinking illumination and yet compensating so that on average the illumination is perceptively comparable to continuous illumination, renders motion blurring masking provided by the present invention less user noticeable.

More optionally, in the display apparatus, the one or more segments excited in a blinking manner are excited in a period including immediately prior to refreshing of corresponding regions of the pixel array. Implementing blinking to occur when array pixels have optically stabilized assists to reduce apparent motion blurring.

Optionally, in the display apparatus, the segments of the illumination source are disposed in a series of rows or columns. Alternatively, in the display apparatus, the segments of the illumination source are preferably disposed in a two-dimensional matrix.

Optionally, in the display apparatus, the signal processor includes an analyzer for analyzing a sequence of consecutive images conveyed via the input signal for determining a degree of motion therein for control one or more segments of the illumination source.

Optionally, in the display apparatus, the pixel array is implemented as a liquid crystal pixel array device operable to transmit illumination generated by the illumination source.

Optionally, in the display apparatus, illumination generated from one or more of the segments is reduced and transmission of one or more corresponding regions of the pixel array enhanced for enhancing black-level rendition exhibited in operation by the display apparatus. Apart from reducing apparent motion blurring, the invention is also capable of providing enhanced color contrast.

Optionally, in the display apparatus, the illumination source and the pixel array are overlaid in relatively close mutual proximity. Relatively close proximity is employed here to indicate that the illumination source and the pixel array are placed sufficiently close so that, for illumination purposes, there is correspondence between given segments of the illumination device with corresponding regions of the pixel array.

These and other aspects of the invention are apparent from and will be elucidated with reference to the embodiments described hereinafter.

### DESCRIPTION OF THE DRAWINGS

Embodiments of the invention will now be described, by way of example only, with reference to the following drawings wherein:

FIG. 1 is a schematic illustration of principal parts of a back-lighting liquid crystal display (LCD) according to the present invention;

FIG. 2 is a schematic diagram of a back-lighting device of the LCD in FIG. 1;

FIG. 3 is an illustration of a signal processing occurring in operation in the LCD of FIG. 1;

FIG. 4 is an illustration of selectively modified LCD illumination in response to local motion properties of a sequence of images being presented on the LCD of FIG. 1; and

FIG. 5 is a timing diagram illustrating signals applied to the back-lighting device of the LCD and to pixels of the LCD.

### DESCRIPTION OF EMBODIMENTS OF THE INVENTION

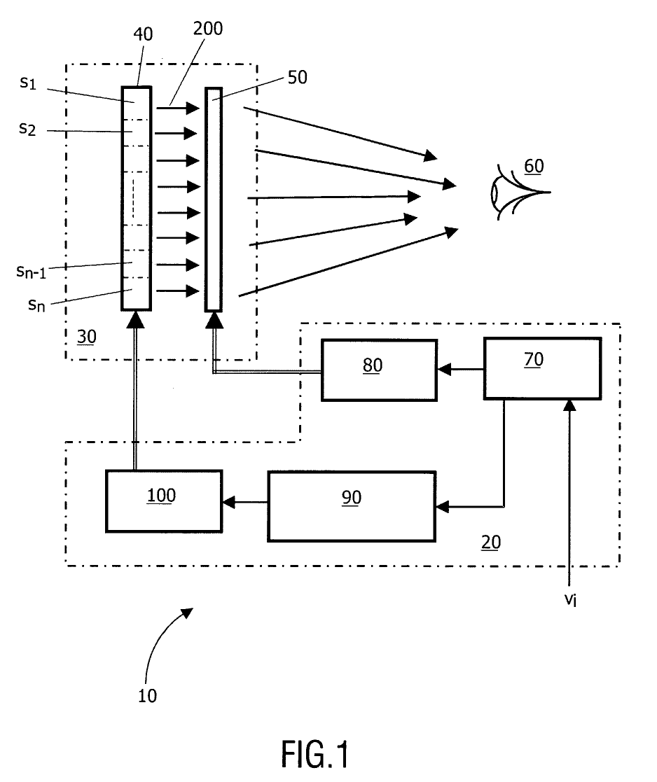

In FIG. 1, there is shown a liquid crystal display according to the invention, the display being indicated generally by 10. The display 10 comprises an electronic display driver unit 20 coupled to a display unit 30. The display unit 30 comprises a panel back-lighting device 40 mounted in relatively close proximity to a liquid crystal pixel array 50 including associated thin-film-transistor (TFT) address decoding circuits integrated therein. The pixel array 50 is interposed in line-of-site between the back-lighting device 40 and a viewer or user denoted by 60.

The display driver unit 20 includes an input data buffer 70 for receiving an input signal vᵢ to be displayed to the viewer or user 60 via the display unit 30. An output of the buffer 70 is connected to a display driver 80 for appropriately distributing pixel drive signals to TFT's of the pixel array 50. The buffer 70 is also coupled to a motion analyzer 90 whose output is coupled via back-light driver unit 100 to the back-lighting device 40.

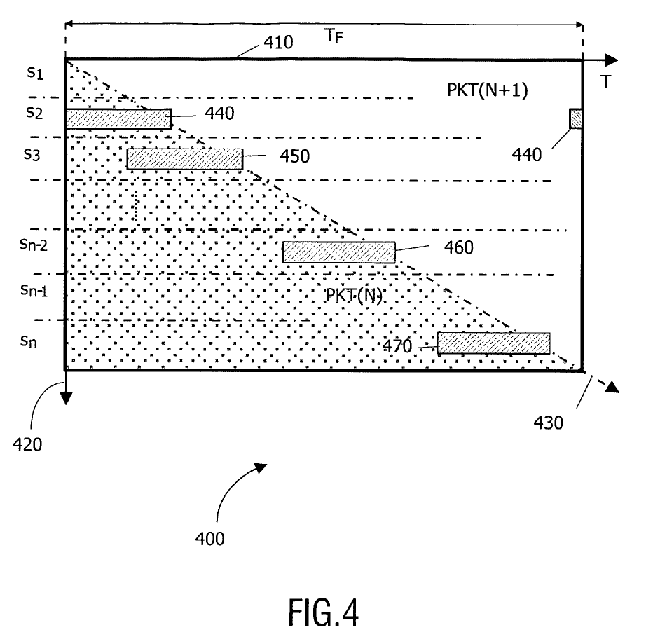

Operation of the display 10 will be described briefly in overview. The data buffer 70 receives the input signal vᵢ and stores it on a image-by-image basis as digital data in a memory of the buffer 70. Moreover, the buffer 70 formats the data into a suitable form for passing to the driver unit 80 which outputs data on a frame-by-frame basis according to a refresh cycle as depicted in FIG. 4. The refresh cycle updates rows of the pixel array 50; alternatively, columns are updated depending upon the design of the pixel array 50.

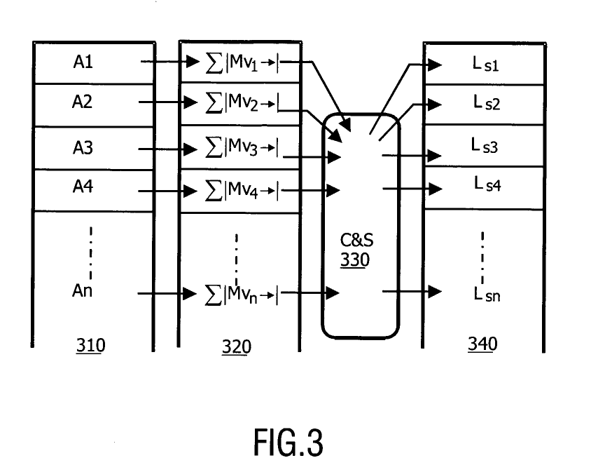

The motion analyzer 90 also receives buffered input data from the data buffer 70 and applies motion analysis to a present image and one or more previous corresponding images in sequence to determine regions of motion within an image to be presented to the user or viewer 60 via the pixel array 50. After executing such motion analysis, for example by vector processing, the analyzer 90 is operable to control selectively which form of drive waveform to apply to each segment s₁ to sₙ of the back-lighting device 40 as will be elucidated in greater detail later. Thus, illumination 200 provided from one of the segment s₁ to sₙ of the back-lighting device 40 is modulated in response to a degree of motion occurring in corresponding parts of the input signal vᵢ. This degree of motion may be determined from motion vector analysis in the analyzer 90, occurring in a corresponding part of the video signal. With a corresponding part is meant that part of the input signal vᵢ that corresponds to one of the regions A1 to An (see FIG. 3) of the images being displayed on a region of the pixel array, which receives light of a corresponding segment sᵢ of the back-lighting device 40.

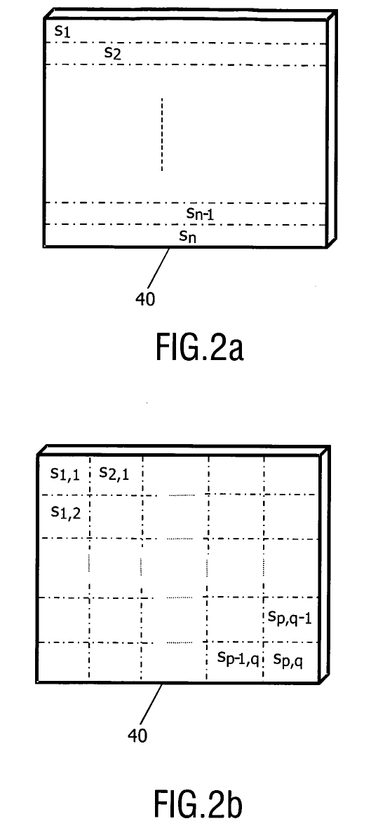

The back-lighting device 40 is preferably implemented as depicted in FIGS. 2a and 2b with regard to its segments s₁ to sₙ. When the segments are implemented as stripes as in FIG. 2a, the stripes are preferably disposed in the display unit 30 in a direction corresponding to the sequence, in which the pixels are updated. For example, when the pixel array 50 is updated row-by-row from a top of the pixel array 50 to a bottom thereof, the back-lighting device 40 is preferably orientated relative to the pixel array 50 so that a longitudinal axis of each of its stripes is substantially parallel to corresponding rows of the pixel array 50. As an alternative to stripes, namely a one dimensional array of the segments s₁ to sₙ, the segments s₁ to sₙ can be implemented as a multi-dimensional array, namely a two-dimensional array as depicted in FIG. 2b. In FIG. 2b, there are p columns and q rows of the segments s_{1 1} to s_{pq}. In one embodiment of the invention, there are provided sixteen lamps grouped into eight segments: see FIG. 2a. The eight segments are controlled by eight control signals from the analyzer 90. Standard contemporary back-lighting units for pixel liquid crystal displays are usually implemented such that their illumination sources, for example lamps, are disposed horizontally in rows.

The analyzer 90 is arranged to operate in a manner as depicted in FIG. 3. Regions A₁ to Aₙ of an image to be displayed on the pixel array 50 are stored in the buffer 70 as denoted by a step 310. These regions A1 to An are then in a step 320 analyzed in the analyzer 90 in respect of one or more preceding images to determine therefrom a sum of motion vectors Σ|Mv₁|, Σ|Mv₂|, Σ|Mv₃|, Σ|Mv₄|, Σ|Mvᵥ| for each of the corresponding regions A1 to An. The principles of motion vectors are known and need no further elaboration here. New is the determination of the sum of motion vectors per region. In a step 330, the analyzer 90 determines drive signals suitable for the segments s₁ to sₙ, when the back-lighting device 40 is implemented as in FIG. 2a, alternatively drive signals suitable for the segments s_{1,1} to s_{p,q}, when the back-lighting device 40 is implemented as in FIG. 2b. For example, if a sum of motion vectors in a region exceeds a predetermined value, the signals for this region are adapted to operate the corresponding segment sᵢ of the back-lighting device 40 in a blinking mode. Alternatively, in order to reduce the risk of visible flicker, the number of regions which are driven in a blinking mode may be limited to a predetermined number. In this case, in step 330 the regions A1 to An are selected, which have the largest sum of the motion vectors.

In a step 340, the driver unit 100 is operable to drive lamps Lₛ₁ to Lₛₙ associated with the segments s₁ to sₙ; similarly, signals are output from the driver unit 100 to drive lamps of the segments s_{1,1} to s_{p,q} when the configuration of FIG. 2b is employed.

In operation, the analyzer 90 and its associated driver unit 100 control the times when the segments s₁ to sₙ are illuminated and the brightness of the segments s₁ to sₙ when illuminated. In a first situation, when relatively little motion occurs within a first subset of these segments s₁ to sₙ, the lamps of this first subset are substantially continuously illuminating this first subset; alternatively, the lamps are strobed at a relatively high frequency whereat flicker is not user-discernible. In a second situation, when considerable motion occurs within a second subset of segments s₁ to sₙ, the analyzer 90 outputs strobed drive signals via the driver unit 100 for associated lamps of the second subset so that these lamps are strobe illuminating this second subset, when corresponding pixel elements of the pixel array 50 have switched state and have stabilized; such strobe drive is preferably arranged to drive these lamps at a relatively high peak intensity so that the average perceived intensity of the pixels corresponding to the second subset does not appear substantially different in intensity to how they would appear were the back-lighting unit 40 to provide a continuous illumination.

This selective approach to controlling operation of the segments s₁ to sₙ of the back-lighting device 40 is of benefit in that the driver unit 100 is capable when relatively little image motion occurs of driving continuously and/or in a high-frequency strobed manner segments of the back-lighting device 40. The driver unit 100 is implemented using switch-mode power supplies which give rise to less peak current surges when operated in such a continuous manner. Moreover, reduced current surges also results in potentially less interference and cross-talk, for example from video to audio circuits.

Operation of the display 10 will be further elucidated with reference to FIG. 4. In FIG. 4, there is shown a graph indicated generally by 400 comprising an abscissa axis 410 denoting time T and an ordinate axis 420 denoting segments s₁ to sₙ of the back-lighting device 40. The axis 410 represents time of a refresh cycle for the pixel array 50 such that a time T_{F} denotes a frame update period for the pixel array 50. Pixels in the pixel array 50 are updated in a manner which sweeps down the pixel array 50, this manner being represented by an diagonal axis 430 on the graph 400. A shaded area PKT(N) below the axis 430 corresponds to a present image no. N whereas an un-shaded area PKT(N+1) above the axis 430 corresponds to a new frame being written to TFT circuits of the pixel array 50. In segments s₁ and sₙ₋₁, there is relatively little motion occurring in associated pixels of the array 50 so these segments s₁, sₙ₋₁ are illuminated continuously and/or using a high-frequency strobe as elucidated in the foregoing; such continuous and/or high-frequency strobed operation is conveniently referred to as “non-blinking”. However, in segments s₂, s₃, sₙ₋₂, sₙ, there is considerable motion in pixels associated thereto, such that these segments s₂, s₃, sₙ₋₂, sₙ are excited in pulsed mode as denoted by bars 440, 450, 460, 470 respectively as described in the foregoing; this pulsed mode of operation is conveniently referred to as “blinking”. The width of the bars 440, 450, 460, 470 indicates the duration of the blinking pulses. Pulsed illumination is applied to these segments s₂, s₃, sₙ₋₂, sₙ when their corresponding pixels have optically stabilized in operation after being updated. As various regions of the pixel array 50 have temporally-varying images presented thereon, occurrence of pulse periods denoted, for example, by the bars 440, 450, 460, 470 will vary dynamically from given segments s₁ to sₙ to others thereof. Preferably the pulsed illumination is applied during a time period immediately preceding a period wherein the pixels in the corresponding region are updated.

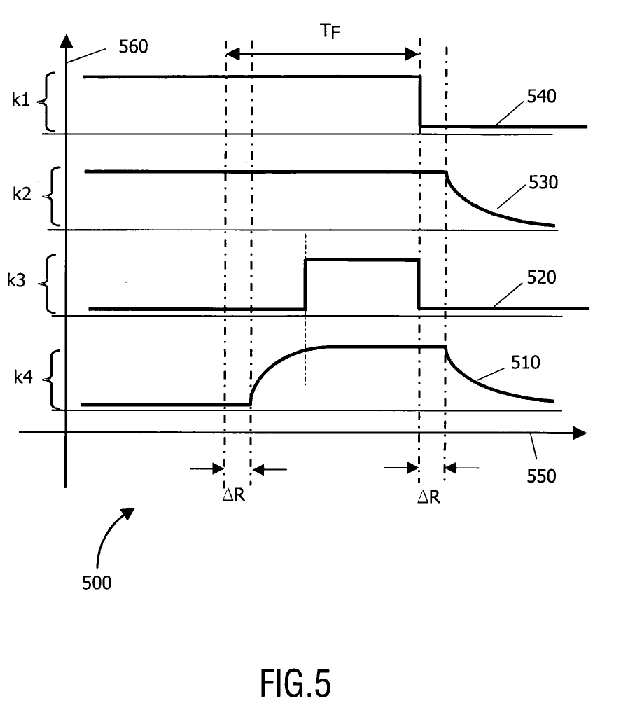

In FIG. 5, a series of curves are shown in a graph indicated generally by 500. The graph 500 comprises an abscissa axis 550 denoting time, and an ordinate axis 560 denoting signal states. Four curves k1, k2, k3, k4 are also shown denoted by 540, 530, 520, 520 respectively. A time interval ΔR is a refresh time for updating TFT circuits of the pixel array 50. The curves k1, k2 are illustrative of a non-blinking segment of the back-lighting device 40 wherein the curve k1 is a drive current from the driver unit 100 to the back-lighting device 40 relevant for a non-blinking segment; moreover, the curve k2 illustrates optical transmission of pixels associated with the non-blinking segment. The curve k1 switches from an illumination ON state to an illumination OFF state at an end of non-blinking period before an exponential change in optical state of corresponding pixels occurs as result of an update of the pixels by the display driver 80.

The curve k3 relates to a blinking segment of the back-lighting device 40 wherein the curve 520 shows drive to the back-lighting device 40 relevant for a blinking region, whereby the high level corresponds to an ON-state. This ON-state is provided once the corresponding pixels have optically stabilized. The drive is preferably applied up to a point in time immediately before updating the corresponding pixels. Employing blinking in the curve k3 at this point in time considerably assists to mask from the user or viewer 60 an exponential reduction in optical activity as illustrated in the curve k4 after an end of on ON-state for the curve 520. More important, however, this blinking masks motion artefacts, which would become visible as result of the sample-and-hold behavior of the pixel array 50.

In the foregoing, there is described a display apparatus wherein back-lighting is provided continuously and/or at a relatively high frequency, namely “non-blinking”, for relatively inactive regions of an image being displayed to reduce visual flicker effects, whereas the back-lighting is provided in a pulsed manner, namely “blinking”, for relatively active regions of an image being displayed. By such an approach, flicker of the image to the viewer or user is selectively reduced whilst simultaneously regions of the image in which motion occurs are perceived by the user or viewer to suffer less from image smearing due to sample-and-hold behavior of LCD pixels. Such a hybrid approach requires back-lighting whose optical output is susceptible to being modulated at a faster rate than its associated LCD.

It will be appreciated that embodiments of the invention described in the foregoing are susceptible to being modified without departing from the scope of the invention as defined by the accompanying claims.

Optionally, the analyzer 90 is selectively operable to reduce light output from a selected segment s₁ to sₙ (or several segments) of the back-lighting device 40 when corresponding pixels of the pixel array 50 are driven to provide substantially black level, or a dark gray level thereby potentially improving black-level rendition exhibited by the display 10. This means for dark scenes presented to the user or viewer 60, lamps of the concerned segment s₁ to sₙ of the back-lighting device 40 are operable to generate less light and a corresponding video level being processed within the driver 80 is correspondingly increased to enhance light transmission through corresponding array of pixels. Such a manner of operation of the display 10 is capable of enhancing efficiency of operation of the display 10; such power saving is attractive when the display 10 is employed in portable battery-operated equipment such as portable DVD viewers and lap-top computers. Moreover, such a manner of operation is also pertinent for wide-screen LCD televisions in which power dissipation within the back-lighting device 40 and associated driver 100 can amount to several ten's of Watts dissipation which can represent a design problem regarding cooling ventilation in equipment where cooling fans are not desirable on account of aesthetic acoustic noise issues.

The display 10 is capable of being modified so that a duty cycle of drive applied to the segments s₁ to sₙ of the back-light unit 40 is varied in response to content of the input signal vᵢ. Optionally, the duty cycle is varied in a continuous manner.

The display 10 is most preferably implemented so that the back-lighting device 30 includes sixteen lamps coupled together in eight groups forming eight regions s₁ to sₙ for control by eight drive signals generated from the driver 100.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display apparatus (10) including:
(a) an illumination source (40) comprising a plurality of individually addressable segments (s₁ to sₙ; s_{1,1} to s_{p,q}) for generating light and having mutually independently controllable light emissions;
(b) a pixel array (50) for optically modulating the light generated by the illumination source (40) to generate a series of images for user-viewing; and
(c) a signal processor (20) for processing an input signal (vᵢ) to drive the illumination source (40) and the pixel array (50) so as to display the series of images corresponding to the input signal (vᵢ), wherein the segments (s₁ to sₙ; s_{1,1} to s_{p,q}) of the illumination source (40) are excited in operation by the signal processor (20) in response to a degree of motion occurring in corresponding parts of the input signal (vᵢ).

2. A display apparatus (10) as claimed in claim 1, wherein the signal processor (20) is operable to excite one or more of the segments (s₁ to sₙ) in a blinking manner when corresponding parts of the input signal (vᵢ) include a degree of motion that exceeds a predetermined value.

3. A display apparatus (10) as claimed in claim 2, wherein the signal processor (20) is operable to excite one or more of the segments (s₁ to sₙ) in a continuous non-blinking manner and/or in a high-frequency strobed manner when corresponding parts of the input signal (vᵢ) include a degree of motion that is below the predetermined value.

4. A display apparatus (10) as claimed in claim 2, wherein light generated by the one or more segments (s₁ to sₙ) excited in the blinking manner is subject to elevated peak illumination so that the generated illumination therefrom is on average at a substantially same level as segments (s₁ to sₙ) of the illumination source (40) excited in a non-blinking continuous and/or high-frequency strobed manner.

5. A display apparatus (10) as claimed in claim 2, wherein the one or more segments excited in a blinking manner are excited in a period including a point in time immediately prior to refreshing of corresponding regions of the pixel array.

6. A display apparatus (10) as claimed in claim 1, wherein the segments (s₁ to sₙ) of the illumination source (40) are disposed in a series of rows or columns.

7. A display apparatus (10) as claimed in claim 1, wherein the segments (s_{1,1} to s_{p,q}) of the illumination source (40) are disposed in a two-dimensional matrix.

8. A display apparatus (10) as claimed in claim 1, wherein the pixel array (50) is implemented as a liquid crystal pixel array device operable to transmit illumination generated by the illumination source (40).

9. A signal processor (20) for processing an input signal (vᵢ) to drive an illumination source (40) and a pixel array (50) so as to display a series of images corresponding to the input signal (vᵢ), wherein the processor (20) is operable to excite one or more segments (s₁ to sₙ) of the illumination source (40) in response to a degree of motion occurring in corresponding parts of the input signal (vᵢ).

10. A method of displaying a series of images conveyed by an input signal (vᵢ) on a display apparatus (10), said display apparatus including:
(a) an illumination source (40) comprising a plurality of individually addressable segments (s₁ to sₙ; s_{1,1} to s_{p,q}) for generating light and having mutually independently controllable light emissions; and
(b) a pixel array (50) for optically modulating the light generated by the illumination source (40) to generate a series of images for user-viewing, the method including the steps of:
processing an input signal (vᵢ) to detect a degree of motion occurring in parts of the input signal (vᵢ) corresponding to the segments (s₁ to sₙ; s_{1,1} to s_{p,q}); and
driving the illumination source (40) and the pixel array (50) so as to display the series of images corresponding to the input signal (v₁), wherein the segments (s₁ to sₙ; s_{1,1} to s_{p,q}) of the illumination source (40) are excited in response to the degree of motion.
